(19) United States
(12) Patent Application Publication
(10) Pub. No.: US 2015/0344366 A1
(43) Pub. Date: Dec. 3, 2015

(54) POLYMER CEMENT COMPOSITION AND CEMENTING METHOD

(71) Applicant: ASAHI GLASS COMPANY, LIMITED, Tokyo (JP)

(72) Inventors: Ken IRUYA, Tokyo (JP); Takeshi Yamada, Tokyo (JP)

(73) Assignee: ASAHI GLASS COMPANY, LIMITED, Tokyo (JP)

(21) Appl. No.: 14/820,685

(22) Filed: Aug. 7, 2015

Related U.S. Application Data
(63) Continuation of application No. PCT/JP2014/059882, filed on Apr. 3, 2014.

(30) Foreign Application Priority Data
Apr. 10, 2013 (JP) 2013-082105

(51) Int. Cl. C04B 16/04; C09K 8/46

(52) U.S. Cl. CPC C04B 16/04; C09K 8/46; C04B 2103/65

(57) ABSTRACT

To provide a polymer cement composition which, when hardened, is less susceptible to cracking by oil such as petroleum, and a cementing method using it.

A polymer cement composition comprising cement, a polymer and water, wherein the polymer is a fluorinated polymer, and the degree of swelling obtained by the following measuring method is from 0 to 30%. (Method for measuring degree of swelling): A 1 mm-thick sheet made of the polymer is immersed in kerosene at a temperature within a range of 23±2° C. for 24 hours, whereby the volume change (%) as between before and after the immersion is measured, and the measured value is taken as the degree of swelling.

### TECHNICAL FIELD

The present invention relates to a polymer cement composition and a cementing method using it.

### BACKGROUND ART

Heretofore, as one of admixtures to be added to concrete or mortar, a liquid proof agent has been available for the purpose of improving a waterproofing property. Since a long time ago, as such a liquid proof agent, an inorganic additive such as calcium chloride, sodium silicate or silicic acid powder, or an organic additive such as a higher fatty acid, has been used. However, each of them has had a problem in its waterproof effect or in long-term stability of the effect. In view of such a problem, it has recently been proposed to employ a polymer as a liquid proof agent. When concrete or mortar containing a polymer is hardened, a continuum of the polymer will be formed, whereby the liquid proofing property and water-tightness will be excellent. Further, depending upon the type of the polymer to be used, various effects may be provided such as a water retention ability, an adhesion property, an anticorrosion property, a freeze-thaw resistance, an impact resistance, an abrasion resistance, reduction of drying shrinkage, etc. Therefore, concrete or mortar containing a polymer, i.e. so-called polymer cement concrete or polymer cement mortar, is used in a wide range of applications. Such applications include, for example, roofing slabs, water storage tanks, pools, septic tanks, silos, etc. utilizing the liquid proofing property, as well as waste drainage channels, chemical plant floors, joint sealants for acid proof tiles, chemical warehouses, etc. utilizing the anticorrosion property, adhesives for e.g. tiles, floor materials, heat insulating materials, etc., finish coating materials, repairing materials, etc.

Polymers for cement admixtures presently employed, are classified into rubber latex type (natural rubber, various synthetic rubbers) and resin emulsion type (thermoplastic resins, thermosetting resins, bituminous substances). The rubber latex type may, for example, be natural rubber latex, chloroprene latex, styrene butadiene rubber latex, acrylonitrile butadiene rubber latex, methyl methacrylate butadiene rubber latex, etc. (see e.g. Patent Document 1). The resin emulsion type may, for example, be an ethylene vinyl acetate emulsion, a polyacrylic acid ester emulsion, a polyvinyl acetate emulsion, etc. (see e.g. Patent Document 2).

On the other hand, in excavation for petroleum, natural gas, etc., cementing is carried out by applying a cement slurry prepared from cement and water, or cement, water and additives, to various sites in a drilling well, to inside of a casing, or to an annulus outside of a casing.

Such a cement slurry for cementing, particularly for an oil well, is predicated on use under high-temperature and high-pressure conditions, as is different for civil engineering and construction, and accordingly, high quality portland cement is used as the base cement, and various additives are added to adjust the specific gravity and viscosity, the time required for hardening, the strength, etc. As main additives to be used for such purposes, a hardening retarder, a hardening accelerator, a dispersing agent, a dehydration reducing agent, a low specific gravity additive, a high specific gravity additive, etc. may be mentioned (see e.g. Non-patent Document 1).

### PRIOR ART DOCUMENTS

### Patent Documents

Patent Document 1: JP-A-2001-354463
Patent Document 2: JP-A-2000-211955

### Non-Patent Document

Non-patent Document 1: Sekiyu Kaihatsu Jiho No. 158 (08.08), p 43-50

### DISCLOSURE OF INVENTION

### Technical Problem

Under high-temperature and high-pressure conditions like in an oil well, oil such as petroleum may penetrate and permeate through hardened cement and leak out of the oil well. Leakage of oil is likely to cause a fire.

In order to prevent leakage of oil, it is conceivable to add a liquid proof agent to a cement slurry for cementing.

However, according to a study made by the present inventers, it has been found that if cementing is carried out by adding a conventional polymer commonly used as a liquid proof agent to a cement slurry, cracking is likely to be formed in cement in an oil well. If cracking is formed in cement, oil is likely to leak out from the cracked portion even if the liquid proofing property of cement itself is improved.

In view of the above situation, the present invention has been made, and it is an object of the present invention to provide a polymer cement composition which, after hardened, is less susceptible to cracking by oil such as petroleum, and a cementing method using it.

### Solution to Problem

As a result of an extensive study, the present inventors have found that if a polymer is added to a cement slurry, oil such as petroleum penetrated into cement in an oil well tends to let the polymer in the cement substantially swell and be disintegrated to cause cracking of the cement.

The present invention has been made based on the above finding and provides a polymer cement composition and a cementing method having the following constructions [1] to [11].

[1] A polymer cement composition comprising cement, a polymer and water, wherein the polymer is a fluorinated polymer, and the degree of swelling obtained by the following measuring method is from 0 to 30%:

### (Method for Measuring Degree of Swelling)

A 1 mm-thick sheet made of the polymer is immersed in kerosene at a temperature within a range of 23±2° C. for 24 hours, whereby the volume change (%) as between before and after the immersion is measured, and the measured value is taken as the degree of swelling.

[2] The polymer cement composition according to the above [1], wherein the fluorinated polymer is at least one member selected from the group consisting of the following fluoro-rubber (F1) and the following fluoro-resin (F2):

Fluoro-rubber (F1): at least one fluoro-rubber selected from the group consisting of a vinylidene fluoride/hexafluoropropylene type copolymer (FKM), a tetrafluoroethylene/propylene type copolymer (FEPM) and a tetrafluoroethylene/perfluoro(alkyl vinyl ether) type copolymer (FFKM),

Fluoro-resin (F2): at least one fluoro-resin selected from the group consisting of an ethylene/tetrafluoroethylene type copolymer (ETFE), a tetrafluoroethylene/perfluoro(alkyl vinyl ether) type copolymer (PFA), a polytetrafluoroethylene (PTFE), a polyvinylidene fluoride (PVDF), a tetrafluoroethylene/hexafluoropropylene type copolymer (FEP), a polychlorotrifluoroethylene (PCTFE) and an ethylene/chlorotrifluoroethylene type copolymer (ECTFE).

[3] The polymer cement composition according to the above [2], wherein the fluorinated polymer contains the fluoro-rubber (F1).
[4] The polymer cement composition according to any one of the above [1] to [3], wherein the volume change measured by the following measuring method, of the polymer, is from −30 to 30%:

### (Method for Measuring Volume Change)

A 1 mm-thick sheet made of the polymer is immersed in a 50% sodium hydroxide aqueous solution at a temperature within a range of 100±5° C. for 72 hours, whereby the volume change as between before and after the immersion is measured.

[5] The polymer cement composition according to any one of the above [1] to [4], wherein the polymer is in powder form, and its average particle size is from 0.5 to 1.5 mm.
[6] The polymer cement composition according to any one of the above [1] to [5], wherein a filler is added to the polymer.
[7] The polymer cement composition according to any one of the above [1] to [6], wherein the polymer is a re-dispersible polymer powder.
[8] The polymer cement composition according to any one of the above [1] to [7], wherein the polymer content in the polymer cement composition is such that the ratio (P/C) of the mass (P) of the polymer to the mass (C) of the cement is at least 10% and at most 40%.
[9] The polymer cement composition according to any one of the above [1] to [8], wherein the fluorinated polymer is a tetrafluoroethylene/propylene binary copolymer, a tetrafluoroethylene/propylene/vinylidene fluoride ternary copolymer, a tetrafluoroethylene/perfluoro(alkyl vinyl ether) type copolymer, or an ethylene/tetrafluoroethylene type copolymer.
[10] The polymer cement composition according to any one of the above [1] to [9], wherein carbon black is added to the fluorinated polymer in an amount of from 5 to 100 parts by mass per 100 parts by mass of the fluorinated polymer.
[11] A cementing method having a step of conducting cementing by using the polymer cement composition as defined in any one of the above [1] to [10].

### Advantageous Effects of Invention

According to the present invention, it is possible to provide a polymer cement composition which, when hardened, is less susceptible to cracking by oil such as petroleum, and a cementing method using it.

### DESCRIPTION OF EMBODIMENTS

### Polymer Cement Composition

The polymer cement composition of the present invention comprises cement, a polymer and water.

The cement is not particularly limited and may suitably be selected for use among known cements in consideration of e.g. the application of the polymer cement composition. As such cements, for example, ordinary portland cement, high-early-strength portland cement, ultra high-early-strength portland cement, moderate-heat portland cement, sulfate-resistant portland cement, silica cement, fly ash cement, portland blast-furnace slag cement, jet-cement, white portland cement, mixed cement, alumina cement, magnesia cement and a mixture thereof, may be mentioned.

In a case where the polymer cement composition of the present invention is to be used for cementing in an oil well, the cement is preferably one which is commonly used as cement for an oil well. Cement for an oil well is predicated on use under high-temperature and high-pressure conditions as is different for civil engineering and construction, and therefore, it is common to use high quality portland cement by adding various additives thereto to adjust the characteristics such as the specific gravity and viscosity, the time required for effects, the strength, etc. As such cement, cements in classes A to H specified in the standards of API (American Petroleum Institute) “API SPEC 10A Specification for Cements and Materials for Well”, may be mentioned.

The polymer to be used for the polymer cement composition of the present invention is a fluorinated polymer, of which the degree of swelling obtained by the following measuring method (hereinafter referred to also as the degree of swelling by immersion in kerosene) is from 0 to 30%. The degree of swelling is preferably from 0 to 20%, more preferably from 0 to 15%, further preferably from 0 to 10%, most preferably from 0 to 5%. When the degree of swelling is within such a range, in a case where the polymer cement composition containing such a fluorinated polymer is used for cementing and hardened, cracking by oil such as petroleum is less likely to occur even under such high-temperature and high-pressure conditions as in an oil well. The closer the degree of swelling to 0%, the better the above effects.

### (Method for Measuring Degree of Swelling)

A 1 mm-thick sheet made of the polymer is immersed in kerosene at a temperature within a range of 23±2° C. for 24 hours, whereby the volume change (%) as between before and after the immersion is measured, and the measured value is taken as the degree of swelling.

Further, of the polymer, the volume change measured by the following measuring method (hereinafter referred to also as the volume change by immersion in hot alkali) is preferably from −30 to 30%, more preferably from −20 to 20%, particularly preferably from −10 to 10%. When the volume change is within such a range, the polymer will function as a polymer cement additive, and the cement strength will be improved. The closer the volume change to 0%, the better the above effects, such being preferred.

### (Method for Measuring Volume Change)

A 1 mm-thick sheet made of the polymer is immersed in a 50% sodium hydroxide aqueous solution at a temperature within a range of 100±5° C. for 72 hours, whereby the volume change as between before and after the immersion is measured.

The sheet to be used in the measurement of the degree of swelling or the volume change is prepared by the following procedure.

In a case where the fluorinated polymer is a rubber in a solid state such as in powder form, the defined amount is put in a formwork and subjected to hot pressing at 50° C. for 5 minutes to obtain a 1 mm-thick sheet.

In a case where the fluorinated polymer is a resin in a solid state, the defined amount is put in a formwork, heated to at least the melting point and hot-pressed to obtain a 1 mm-thick sheet.

In a case where the fluorinated polymer is liquid such as a latex or dispersion, the solid content in the liquid is agglomerated and dried to obtain a solid-state rubber or resin, which is then molded as described above to obtain a 1 mm-thick sheet.

The fluorinated polymer may be a fluoro-rubber or a fluoro-resin.

The fluoro-rubber is an elastomer (elastic polymer) containing fluorine atoms, which has a glass transition temperature lower than room temperature and which has elasticity at room temperature. The fluoro-rubber to be incorporated to a polymer cement composition may be uncrosslinked one (crude rubber, full compound, pre-compound) or crosslinked one.

The fluoro-resin is a polymer containing fluorine atoms, which has a melting point and glass transition temperature higher than room temperature. The fluoro-resin may, for example, be a thermoplastic fluoro-resin or a thermosetting fluoro-resin.

The fluorinated polymer, of which the degree of swelling by immersion in kerosene is at most 30%, may, for example, be the following fluoro-rubber (F1) or fluoro-resin (F2). Either one of the fluoro-rubber (F1) and the fluoro-resin (F2) may be used alone, or both of them may be used in combination.

Fluoro-rubber (F1): at least one fluoro-rubber selected from the group consisting of a vinylidene fluoride/hexafluoropropylene type copolymer (FKM), a tetrafluoroethylene/propylene type copolymer (FEPM) and a tetrafluoroethylene/perfluoro(alkyl vinyl ether) type copolymer (FFKM).

Fluoro-resin (F2): at least one fluoro-resin selected from the group consisting of an ethylene/tetrafluoroethylene type copolymer (ETFE), a tetrafluoroethylene/perfluoro(alkyl vinyl ether) type copolymer (PFA), a polytetrafluoroethylene (PTFE), a polyvinylidene fluoride (PVDF), a tetrafluoroethylene/hexafluoropropylene type copolymer (FEP), a polychlorotrifluoroethylene (PCTFE) and an ethylene/chlorotrifluoroethylene type copolymer (ECTFE).

In the present invention, “type” in a polymer (including a copolymer) means that essential monomer units in the polymer (e.g. vinylidene fluoride units and hexafluoropropylene units in the vinylidene fluoride/hexafluoropropylene type copolymer, or tetrafluoroethylene units and propylene units in the tetrafluoroethylene/propylene type copolymer) are the main components in the polymer. Here, “main components” means that the proportion of the essential monomer units (in a case where the essential monomer units are in plurality, their total amount) to all constituting units to constitute the polymer is at least 50 mol %.

Units (monomer units) mean constituting units to constitute a polymer.

Among fluoro-rubbers (F1), the copolymer composition (molar ratio) of FKM is preferably vinylidene fluoride units/hexafluoropropylene units=from 60/40 to 95/5, more preferably from 70/30 to 90/10, most preferably from 75/25 to 85/15.

In a case where FKM is a vinylidene fluoride/tetrafluoroethylene/hexafluoropropylene type copolymer which further contains tetrafluoroethylene units, its copolymer composition (molar ratio) is preferably vinylidene fluoride units/tetrafluoroethylene/hexafluoropropylene units=from 50/5/45 to 65/30/5, more preferably from 50/15/35 to 65/25/10, most preferably from 50/20/30 to 65/20/15.

The copolymer composition (molar ratio) of FEPM is preferably tetrafluoroethylene units/propylene units=from 40/60 to 70/30, more preferably from 45/55 to 65/35, most preferably from 50/50 to 60/40.

The copolymer composition (molar ratio) of FFKM is preferably tetrafluoroethylene units/perfluoro(alkyl vinyl ether) units=from 50/50 to 95/5, more preferably from 55/45 to 85/15, most preferably from 60/40 to 80/20.

The perfluoro(alkyl vinyl ether) may, for example, be perfluoro(methyl vinyl ether), perfluoro(ethyl vinyl ether), perfluoro(propyl vinyl ether), perfluoro(methoxyethyl ether), perfluoro(methoxyethyl ether), perfluoro(methoxyethyl ether) or perfluoro(propoxyethyl ether). Particularly preferred is perfluoro(methyl vinyl ether), perfluoro(ethyl vinyl ether), or perfluoro(propyl vinyl ether).

These fluoro-rubbers (F1) may contain at least one type of other monomer units other than the essential monomer units within a range not to impair the essential properties. Other monomers to form such other monomer units may, for example, be chlorotrifluoroethylene, trifluoroethylene, vinyl fluoride, ethylene, pentafluoropropylene, tetrafluoroethylene, vinylidene fluoride, ethylidene norbornene, vinyl crotonate, etc.

The content of other monomer units in a fluoro-rubber (F1) is preferably at most 50 mol %, more preferably at most 30 mol %, to the total of all constituting units to constitute the fluoro-rubber (F1).

Specific examples of the fluoro-rubber (F1) may be a vinylidene fluoride/hexafluoropropylene type copolymer, a vinylidene fluoride/tetrafluoroethylene/hexafluoropropylene type copolymer, a vinylidene fluoride/chlorotrifluoroethylene type copolymer, a tetrafluoroethylene/propylene type copolymer, a tetrafluoroethylene/propylene/vinylidene fluoride type copolymer, a tetrafluoroethylene/propylene/vinyl fluoride type copolymer, a tetrafluoroethylene/propylene/trifluoroethylene type copolymer, a tetrafluoroethylene/propylene/pentafluoropropylene type copolymer, a tetrafluoroethylene/propylene/chrolotrifluoroethylene type copolymer, a tetrafluoroethylene/propylene/ethylidene norbornene type copolymer, a tetrafluoroethylene/propylene/vinyl crotonate type copolymer, a hexafluoropropylene/ethylene type copolymer, a tetrafluoroethylene/perfluoro(alkyl vinyl ether) type copolymer, a vinylidene fluoride/tetrafluoroethylene/perfluoro(alkyl vinyl ether) type copolymer, etc.

Among the above, as the fluoro-rubber (F1), at least one member selected from the group consisting of a tetrafluoroethylene/propylene type copolymer, a vinylidene fluoride/tetrafluoroethylene/hexafluoropropylene type copolymer, and a tetrafluoroethylene/propylene/vinylidene fluoride type copolymer, is preferred from such a viewpoint that the degree of swelling in oil such as kerosene is low, and the alkali resistance is high.

As the fluoro-rubber (F1), one synthesized by a usual method may be employed, or one commercially available may be employed.

As an example of a commercial product of a tetrafluoroethylene/propylene type copolymer, “AFLAS 150E” (manufactured by Asahi Glass Co., Ltd., tetrafluoroethylene/propylene binary copolymer) may, for example, be mentioned.

As an example of a commercial product of a tetrafluoroethylene/propylene/vinylidene fluoride type copolymer, “AFLAS 200P” or “AFLAS 200S” (each manufactured by Asahi Glass Co., Ltd, tetrafluoroethylene/propylene/vinylidene fluoride ternary copolymer) may, for example, be mentioned.

ETFE in the fluoro-resin (F2) is preferably tetrafluoroethylene units/ethylene units=from 75/25 to 30/70 (molar ratio), more preferably from 70/30 to 45/65, most preferably from 70/30 to 50/50.

The perfluoro(alkyl vinyl ether) in PFA is preferably one represented by the formula CF₂=CF—OR^{f} (in the formula, R^{f} is a C₁₋₁₀ perfluoroalkyl group).

PFA is preferably tetrafluoroethylene units/perfluoro(alkyl vinyl ether) units=from 99/1 to 92/8 (molar ratio), more preferably from 99/1 to 95/5.

FEP is preferably tetrafluoroethylene units/hexafluoropropylene units=from 96/4 to 87/13 (molar ratio), more preferably from 95/5 to 85/15.

ECTFE is preferably ethylene units/chlorotrifluoroethylene units=from 68/32 to 14/86, more preferably from 55/45 to 35/65.

As the Mooney viscosity of a fluoro-rubber, value ML₁₊₁₀121° C. after preheating for 1 minute and heating for 10 minutes at 121° C. by means of a large rotor, is preferably from 10 to 250, more preferably from 15 to 200.

The fluoro-resin (F2) may contain at least one type of other monomer units other than the essential monomer units within a range not to impair its essential properties. Other monomers to form such other monomer units may, for example, be a hydrocarbon type olefin such as propylene or butene; a perfluoroolefin such as tetrafluoroethylene (excluding ETFE, PFA and FEP) or hexafluoropropylene (excluding FEP); chlorotrifluoroethylene (excluding PCTFE and ECTFE); a fluoro-olefin having a polymerizable unsaturated group and hydrogen atoms, such as a compound represented by CH₂=CX(CF₂)ₙY (wherein each of X and Y which are independent of each other, is a hydrogen atom or a fluorine atom, and n is an integer of from 2 to 8), vinyl fluoride, vinylidene fluoride (excluding PVDF), trifluoroethylene or a perfluoroalkyl (C₁₋₁₀)ethylene; a vinyl ether such as glycidyl vinyl ether, hydroxybutyl vinyl ether or methyl vinyloxy butyl carbonate; a perfluoro(alkyl vinyl ether) (excluding PFA); a perfluoroalkyl(C₁₋₁₀) allyl ether; a compound represented by CF₂═CF[OCF₂CFX(CF₂)ₘ]ₙOCF₂(CF₂)ₚY [wherein X is a fluorine atom or a trifluoromethyl group, Y is a halogen atom, m is an integer of 0 or 1 (provided that when m is 1, X is limited to a fluorine atom), n is an integer of from 0 to 5, and p is an integer of from 0 to 2]; a vinyl ester such as vinyl acetate, vinyl chloroacetate, vinyl butanoate, vinyl pivalate, vinyl benzoate or vinyl crotonate; a (meth)acrylic acid ester such as a (polyfluoroalkyl) acrylate or a (polyfluoroalkyl) methacrylate; a compound having an acid anhydride residue and a polymerizable unsaturated group, such as maleic anhydride, itaconic anhydride, citraconic anhydride or 5-norbornene-2,3-dicarboxylic acid anhydride; etc.

The content of such other monomer units in the fluoro-resin (F2) is preferably at most 20 mol % to the total of all constituting units to constitute the fluoro-resin (F2).

The average molecular weight of the fluoro-resin (F2) may usually be from 2,000 to 1,000,000. The average molecular weight of the fluoro-resin (F2) is assumed by a viscoelasticity measurement/high temperature SEC method.

As the fluoro-resin (F2), one type may be used alone, or two or more types may be used in combination.

The melt flow rate (hereinafter referred to also as MFR) of the fluoro-resin is preferably from 0.1 to 100 g/10 min., more preferably from 0.1 to 50 g/10 min., at a measuring temperature of the melting point +40° C.

The fluorinated polymer is particularly preferably, as a fluoro-rubber (F1), a tetrafluoroethylene/propylene binary copolymer, a tetrafluoroethylene/propylene/vinylidene fluoride ternary copolymer, or a tetrafluoroethylene/perfluoro(alkyl vinyl ether) copolymer, and particularly preferably, as a fluoro-resin (F2), an ethylene/tetrafluoroethylene type copolymer.

To the fluorinated polymer, additives may be added. That is, at the time of preparing a polymer cement composition, one to be mixed with cement and water, may be a polymer composition having additives added to the fluorinated polymer.

As such additives, known components such as a filler, a crosslinking agent, a crosslinking aid, a processing aid, a lubricant, a lubricating agent, a flame retardant, an antistatic agent, a colorant, etc. may suitably be incorporated.

It is preferred that a filler is added to the fluorinated polymer. By the addition of a filler, it is possible to lower the degree of swelling by immersion in kerosene. Further, it is possible to improve the function to prevent adhesion at the time of forming a powder.

The filler is not particularly limited and may, for example, be carbon black, polytetrafluoroethylene, glass fibers, carbon fibers, white carbon, etc.

Among them, it is particularly preferred to incorporate carbon black as the filler.

The carbon black is not particularly limited, and any carbon black may be used so long as it is one commonly employed as a filler for a rubber or polymer. As specific examples, furnace black, acetylene black, thermal black, channel black, graphite, etc. may be mentioned. Among them, furnace black or thermal black is more preferred from the viewpoint of the reinforcing property, and as specific examples thereof, HAF-LS, HAF, HAF-HS, FEF, GPF, APF, SRF-LM, SRF-HM, MT, etc. may be mentioned. Among these carbon blacks, one type may be used alone, or two or more types may be used in combination.

The amount of carbon black to be added to the fluorinated polymer is preferably from 5 to 100 parts by mass, more preferably from 10 to 50 parts by mass, per 100 parts by mass of the fluorinated polymer.

Carbon black and other fillers other than carbon black may be used in combination.

The amount of such other fillers to be added to the fluorinated polymer is preferably from 5 to 200 parts by mass, more preferably from 10 to 100 parts by mass, per 100 parts by mass of the fluorinated polymer.

To the fluorinated polymer, either one or both of a crosslinking agent or a crosslinking aid may be added. The fluorinated polymer to be used in the present invention, may be cross-linked or may not be cross-linked. In consideration of the oil resistance, it is preferably a cross-linked product at least after hardening. If either one or both of a crosslinking agent and a crosslinking aid are incorporated, even if the fluorinated polymer is not cross-linked at the time of blending into a polymer cement composition, when heated in e.g. an oil well, crosslinking proceeds by the heating, whereby the oil resistance will be improved.

As the crosslinking agent, a known crosslinking agent may suitably be used. It is preferred to use an organic peroxide, particularly from such a view point that a cross-linked rubber product excellent in steam resistance and chemical resistance is thereby readily obtainable.

The organic peroxide may be one which generates radicals under heating in the presence of an oxidation-reduction system, and it is possible to use one which is commonly used as a polymerization initiator, a curing agent or a crosslinking agent mainly for resins or synthetic rubbers. Usually, the organic peroxide is a derivative of hydrogen peroxide, and by the presence of oxygen binding in its molecule, it is thermally decomposable at a relatively low temperature to readily form free radicals. As reactions to be caused by the formed free radicals, an addition reaction to an unsaturated double bond and a reaction to withdraw hydrogen, etc., may be mentioned. Among these reactions, by utilizing the latter hydrogen withdrawing reaction, it is used as a crosslinking agent or a crosslinking accelerator for various synthetic rubbers and synthetic resins or as a modifier for polypropylene.

As organic peroxides to be used for crosslinking of synthetic rubbers, etc., various types of organic peroxides are available. Therefore, it is preferred to properly select one for use so as not to bring about decomposition or scorch due to heat history during kneading of a rubber composition, and so that satisfactory crosslinking can be done at a certain crosslinking temperature within a certain time. As the crosslinking agent, one type may be used alone, or two or more types may be used in combination. The organic peroxide is preferably one having a temperature of from 130 to 220° C. at which its half-life becomes one minute.

As preferred examples of the organic peroxide, 1,1-bis(t-hexylperoxy)-3,5,5-trimethylcyclohexane, 2,5-dimethylhexane-2,5-dihydroperoxide, di-t-butyl peroxide, t-butylcumyl peroxide, dicumyl peroxide, α,α′-bis(t-butylperoxy)-p-diisopropylbenzene, 2,5-dimethyl-2,5-di(t-butylperoxy)-hexane, 2,5-dimethyl-2,5-di(t-butylperoxy)-hexyne-3, dibenzoyl peroxide, t-butylperoxy benzoate, 2,5-dimethyl-2,5-di(benzoylperoxy)hexane, t-butyl peroxy maleic acid, t-hexyl peroxyisopropyl monocarbonate, etc., may be mentioned.

Among them, α,α′-bis(t-butylperoxy)-p-diisopropylbenzene is preferred from the viewpoint of excellent crosslinking property of the fluorinated polymer.

The amount of the crosslinking agent to be added to the fluorinated polymer is preferably from 0.5 to 5 parts by mass, more preferably from 1 to 3 parts by mass, per 100 parts by mass of the fluorinated polymer.

As the processing aid, an alkali metal salt of higher fatty acid may, for example, be mentioned. For example, a stearic acid salt or a lauric acid salt is preferred.

The amount of the processing aid to be added to the fluorinated polymer is preferably from 0.1 to 20 parts by mass, more preferably from 0.2 to 10 parts by mass, per 100 parts by mass of the fluorinated polymer.

The fluorinated polymer (having additives added) is mixed usually in the form of a dispersion or powder, with cement and water, from the viewpoint of dispersibility.

As such a dispersion, a rubber latex or a resin emulsion is available. In each case, the dispersing medium is usually water or an aqueous medium containing a water-soluble organic solvent. The water-soluble organic solvent may, for example, be an alcohol such as ethanol, butanol or t-butanol, a ketone such as acetone, or acetonitrile.

At the time of forming the dispersion, additives such as a surfactant, a dispersion stabilizer, a silicone emulsion-type defoaming agent, etc. may be employed. As such additives, any conventional ones may be employed. In the present invention, such additives may be contained in the polymer cement composition.

The average particle size of the powder form polymer is preferably from 0.3 to 3 mm, more preferably from 0.5 to 1.5 mm. When the average particle size is from 0.5 to 1.5 mm, the strength retention property of the cement will be good.

For the measurement of the average particle size of the powder form polymer, a common particle size measuring method may be used, and the average particle size is a value measured by a vibrating sieve machine.

The powder form polymer may be produced by various known powdering methods, granulating methods, etc. For example, a method of powdering by an action of impact, shear force, etc. by subjecting a solid polymer to a mechanical pulverizer such as a pin mill or an impeller mill, a method of powdering by spraying a liquid having a polymer dispersed in a solvent, in an atmosphere at a temperature of at least the boiling point of the dispersing medium, a method of granulating a polymer by subjecting it to a granulator such as a Henschel mixer, a high speed mixer or a mechano fusion, etc. may be mentioned.

The polymer in the present invention is preferably in powder form, particularly preferably a re-dispersible polymer powder, since the miscibility to cement is good, the obtainable mortar or concrete will have high swelling resistance against oil, and the strength retention of cement will be high.

The re-dispersible polymer powder is a powder form resin which is re-dispersible when water is added thereto, and it is obtainable, for example, by drying one having a stabilizer, etc. added to a rubber latex or resin emulsion.

It is preferred that the above polymer satisfies the quality of a polymer dispersion for cement admixture or a re-dispersible polymer powder as stipulated in JIS A6203: 2008 (Polymer dispersion for cement admixture and re-dispersible polymer powder). That is, it is preferred that the polymer satisfies the following conditions (1-1) to (1-8).

(1-1) Outwardly, there should not be coarse particles, foreign matters, aggregates, etc.

(1-2) In the case of a dispersion, the non-volatile content (total solid content) is at least 35.0%, and in the case of powder form, the volatile content (total mass−total solid content) is at most 5.0%.

(1-3) The bending strength is at least 8.0 N/mm.

(1-4) The strength in compression is at least 24.0 N/mm.

(1-5) The adhesion strength is at least 1.0 N/mm.

(1-6) The water absorption percentage is at most 10.0%.

(1-7) The hydraulic permeability is at most 15 g.

(1-8) The change in length is from 0 to 0.150%.

The content of the polymer in the polymer cement composition is such that the ratio (P/C) of the mass (P) of the polymer to the mass (C) of cement is preferably at most 40%, more preferably from 10 to 30%, particularly preferably from 15 to 25%. When P/C is at most 40%, the cement strength as a polymer cement will be good, and when it is at least 10%, the effect of blending the polymer is sufficiently obtainable.

Further, the polymer/cement ratio may be defined in accordance with JIS A1171.

In the polymer cement composition, the total content of the polymer and cement is preferably from 50 to 100 mass %, more preferably from 70 to 100 mass %.

In the polymer cement composition, the content of water is preferably from 65 to 20 mass %, more preferably from 45 to 20 mass %.

The polymer cement composition of the present invention may further contain other components in addition to cement, the polymer and water, as the case requires, within a range not to impair the effects of the present invention.

As such other components, aggregate, admixture, inflating agent, etc. may be mentioned.

As aggregate, any conventional aggregate may be used, and, for example, sea sand, pit sand, river sand, land sand, crushed sand, blast furnace slag, river gravel, pit gravel, land gravel, sea gravel, crushed stone, slag, etc. may be mentioned.

As admixture, AE (Air Entraining) agent, water-reducing admixture, AE water-reducing admixture, high performance water-reducing admixture, high performance AE water-reducing admixture, fluidizer, corrosion inhibitor, frothing agent, high purity silica, fly ash, blast furnace slag, etc. may be mentioned.

Any one of them may be used alone, or two or more of them may be used in combination.

Particularly, in the present invention, it is preferred that to the above-mentioned aggregate, high purity silica or blast furnace slag to be used as admixture, is mixed for use.

The polymer cement composition of the present invention can be produced by mixing cement, the polymer, water and, as the case requires, other components. By mixing these components, a slurry form polymer cement composition is obtainable.

The mixing order of these components is not particularly limited. Mixing of the components may be conducted by a usual method.

The application of the polymer cement composition of the present invention is not particularly limited, but it is suitable for use in an application which is predicated on use under high-temperature and high-pressure conditions, e.g. cementing at a wellbore formed for e.g. oil drilling.

The polymer cement composition of the present invention contains the polymer, whereby the polymer cement composition after hardened, has a high liquid proofing property. Further, the polymer is a fluorinated polymer, of which the degree of swelling by immersion in kerosene is at most 30%, whereby when a polymer cement composition containing it, is used for cementing and hardened, cracking due to oil such as petroleum is less likely to occur even under high-temperature and high-pressure conditions as in an oil well. Therefore, it is possible to prevent leakage of oil over a long period of time. Such an effect is particularly good in such a case where the fluorinated polymer to be used in the polymer cement composition of the present invention is one having a low volume change at the time of immersion in hot alkali (one having high hot alkali resistance, such as FEPM or FFKM).

The cementing method using the polymer cement composition of the present invention will be described in detail later.

The polymer cement composition of the present invention is useful also for applications other than cementing. Applications other than cementing may, for example, be underground structures (wall materials, floor materials, etc.) at various wells other than a drilling well, hot springs, geothermal power plants, etc.; roof slabs, water storage tanks, pools, septic tanks, etc. utilizing the liquid proofing property; drainage channels, floors of chemical plants, sealing materials for acid-resistant tiles, chemical storage tanks, etc. utilizing the corrosion resistance; etc.

In a case where the fluorinated polymer to be used in the polymer cement composition of the present invention is FEPM or FFKM excellent in steam resistance, the polymer cement composition of the present invention is useful particularly for steam resistance for e.g. underground structures at hot springs, geothermal power plants, tunnel drilling, undersea oilfields, etc., boilers, thermal power plants, etc., which are likely to be exposed to steam at high temperatures.

### [Cementing Method]

The cementing method of the present invention is characterized by comprising a step (hereinafter referred to also as a cementing step) of conducting cementing by using the above-described polymer cement composition of the present invention.

Cementing means applying a cement slurry (in the present invention, the above-described polymer cement composition) to various sites in a drilling well to be used for e.g. oil drilling, to inside of a casing, or to a portion of an annulus outside of a casing.

Cementing is usually classified into primary cementing and secondary cementing. Primary cementing means cementing to be applied to a portion of an annulus outside of a casing immediately after the casing is installed. This primary cementing is one which is necessarily conducted in usual casing and has a role of fixing and protecting the casing and separating it so as to prevent a stratal fluid from penetrating into the production layer. Secondary cementing means cementing which is conducted locally, as the case requires, after the primary cementing.

Cementing to be conducted in the cementing step in the present invention may be primary cementing or secondary cementing.

Cementing may be conducted by a known method. For example, the polymer cement composition of the present invention is transported into a drilling well by a cementing pump and injected to a predetermined site (an open hole, plug back cementing to fill cement inside of a casing, a specific geological stratum, space, etc.).

The application field of the cementing method of the present invention is not particularly limited and may be various drilling wells, but from the viewpoint of the usefulness of the present invention, an oil well is preferred. The application of the present invention is particularly preferred to an oil well with a high depth (e.g. at least 2,000 m from the earth's surface) where the pressure tends to be high and cracking of cement is likely to occur.

### EXAMPLES

Now, the present invention will be described in detail with reference to Examples. However, it should be understood that the present invention is by no means restricted by the following description.

### Test Example 1

With respect to test specimens (rectangular sheets having a thickness of 1 mm) prepared in the following Ex. 1 to 9, the degree of swelling by immersion in kerosene and the volume change by immersion in hot alkali were measured by the following procedures. The results are shown in Table 1.

### [Degree of Swelling by Immersion in Kerosene]

A test specimen was immersed in kerosene at a temperature within a range of 23±2° C. for a prescribed time (24 hours, 70 hours or 166 hours), whereby the volume change (%) as between before and after the immersion, was measured, and the measured value was taken as the degree of swelling. The volume change was calculated by the following formula (1). However, in a case where the test specimen was partially dissolved during the immersion, or the test specimen was disintegrated when taken out from kerosene after the immersion, so that the shape of the test specimen was no longer maintained, no measurement of the degree of swelling was carried out.

Volume change (%)=((Volume after immersion−Volume before immersion)/Volume before immersion)×100 (1)

### [Volume Change by Immersion in Hot Alkali]

A test specimen was immersed in a sodium hydroxide aqueous solution (concentration: 50 mass %) at a temperature within a range of 100±2° C. for a prescribed time (72 hours), whereby the volume change (%) as between before and after the immersion, was measured. The volume change was calculated by the above formula (1). However, in a case where the test specimen was partially disintegrated during the immersion, or in a case where the test specimen was substantially swelled during the immersion and the test specimen was disintegrated when taken out from the sodium hydroxide aqueous solution after the immersion, so that the shape was no longer maintained, no measurement of the volume change was carried out.

### [Measurement of Mooney Viscosity]

In accordance with JIS K6300-1: 2001, using a large rotor, value ML₁₊₁₀121° C. after preheating for 1 minute and heating for 10 minutes at 121° C. was measured.

### [Measurement of Melt Flow Rate (MFR)]

In accordance with ASTM D1238 standards, using Melt Idexer manufactured by Technol Seven Co., Ltd., the mass (g) of a fluorinated copolymer flowing out from a nozzle having a diameter of 2 mm and a length of 8 mm for 10 minutes (unit time) at a temperature of at least the melting point depending upon each resin, e.g. at 297° C. in the case of ETFE or at 372° C. in the case of PFA, under a load of 5 kg, was measured, and the measured value was taken as MFR (g/10 min.).

### Ex. 1

Crude rubber of AFLAS 150E (trade name, manufactured by Asahi Glass Co., Ltd., FEPM, tetrafluoroethylene/propylene binary copolymer, Mooney viscosity ML₁₊₁₀121° C.: 45) was sheeted by hot press at 50° C. and used as a test specimen.

### Ex. 2

Crude rubber of AFLAS 200P (trade name, manufactured by Asahi Glass Co., Ltd., FEPM, tetrafluoroethylene/propylene/vinylidene fluoride ternary copolymer, Mooney viscosity ML₁₊₁₀121° C.: 65) was sheeted by hot press at 50° C. and used as a test specimen.

### Ex. 3

Crude rubber of AFLAS 200S (trade name, manufactured by Asahi Glass Co., Ltd., FEPM, tetrafluoroethylene/propylene/vinylidene fluoride ternary copolymer, Mooney viscosity ML₁₊₁₀121° C.: 60) was sheeted by hot press at 50° C. and used as a test specimen.

### Ex. 4

Crude rubber of AFLAS Premium PM-1100 (trade name, manufactured by Asahi Glass Co., Ltd., FFKM, tetrafluoroethylene/perfluoro(alkyl vinyl ether) copolymer, Mooney viscosity ML₁₊₁₀121° C.: 68) was sheeted by hot press at 50° C. and used as a test specimen.

### Ex. 5

Crude rubber of FKM (trade name: G-901, manufactured by Daikin Industries, Ltd., Mooney viscosity ML₁₊₁₀121° C.: 80) was sheeted by hot press at 50° C. and used as a test specimen.

### Ex. 6

Powder form ETFE (trade name: Fluon TL-581, manufactured by Asahi Glass Co., Ltd., average particle size: 300 μm, MFR (measured temperature: 297° C.):30) was sheeted by hot press at 280° C. and used as a test specimen.

### Ex. 7 (Comparative)

Crude rubber of natural rubber (Mooney viscosity ML₁₊₁₀121° C.: 88) was sheeted by hot press at 50° C. and used as a test specimen.

### Ex. 8 (Comparative)

Crude rubber of silicon rubber (trade name: KE-971-U, manufactured by Shin-Etsu Chemical Co., Ltd., rubber compound grade) was sheeted by hot press at 50° C. and used as a test specimen.

### Ex. 9 (Comparative)

Crude rubber of EPDM (Ethylene/propylene/diene rubber, trade name: Esprene 553, Sumitomo Chemical Co., Ltd.) was sheeted by hot press at 50° C. and used as a test specimen.

TABLE 1

| | | Degree of swelling (%) | | | Volume change |
|---|---|---|---|---|---|
| | | | | 166 | in hot |
| | Polymer | 24 hr | 70 hr | hr | alkali (%) |
| Ex. 1 | AFLAS150E | 2.3 | 5.6 | 8.8 | 4.8 |
| Ex. 2 | AFLAS200P | 0.6 | 2.1 | 3.5 | 0.2 |
| Ex. 3 | AFLAS200S | 0.6 | 1.8 | 2.3 | 0.9 |
| Ex. 4 | AFLAS | 0.1 | 0 | 0.1 | 0.1 |
| | Premium | | | | |
| | 1100 | | | | |
| Ex. 5 | FKM | 2 | −1 | 1 | No |
| | | | | | measurement |
| | | | | | (disintegrated) |
| Ex. 6 | ETFE | −1 | 0 | 0.2 | 0.1 |
| Ex. 7 | Natural | No | No | | |
| | rubber | measurement | measurement | | |
| | (NR) | (partially | (partially | | |
| | | dissolved) | dissolved) | | |
| Ex. 8 | Silicon | No | No | | |
| | rubber | measurement | measurement | | |
| | (VMQ) | (partially | (partially | | |
| | | dissolved) | dissolved) | | |
| Ex. 9 | EPDM | No | 165 | | |
| | | measurement | | | |
| | | (disin- | | | |
| | | tegrated) | | | |

As shown by the above results, with specimens in Ex. 1 to 6 using FEPM (AFLAS 150E, 200P, 200S), FFKM (AFLAS Premium 1100), FKM, ETFE being non-redispersible polymer powders, the degree of swelling by immersion in kerosene was small. Especially with FEPM, FFKM and ETFE, the volume change by immersion in hot alkali was also small.

### Ex. 10 to 18

In accordance with the blend formulations (unit: parts by mass) as shown in Table 2, various additives (as fillers, MT-C: MT carbon, SRF-C: SRF carbon, FEF-C: FEF carbon, calcium carbonate, crosslinking agents, etc.) were added to FEPM, followed by mixing by a twin roll and then by sheeting by hot press at a temperature (50° C.) where no cross linking took place.

The obtained sheet (rectangular sheet having a thickness of 1 mm) was used as a test specimen, the degree of swelling by immersion in kerosene was measured by the same procedure as in Test Example 1. The results are shown in Table 2.

TABLE 2

| | Ex. 10 | Ex. 11 | Ex. 12 | Ex. 13 | Ex. 14 | Ex. 15 | Ex. 16 | Ex. 17 | Ex. 18 |
|---|---|---|---|---|---|---|---|---|---|
| AFLAS150E | 100 | 100 | | | | | | | |
| AFLAS200P | | | 100 | 100 | 100 | 100 | | | |
| AFLAS200S | | | | | | | 100 | 100 | 100 |
| MT-C | 10 | 60 | 25 | | | | 50 | | |
| SRF-C | | | | | | | | 20 | 20 |
| FEF-C | | | | 5 | 50 | 10 | | | |
| Calcium carbonate | 40 | | | | | 40 | | | |
| Peroxide | 1 | 1 | 1 | 1 | 1 | 1 | | | |
| Triallyl isocyanate | 5 | 5 | 5 | 5 | 5 | 5 | | | |
| Bisphenol AF | | | | | | | 1 | 1.5 | 1.5 |
| Tetrabutyl ammonium hydroxide | | | | | | | 2 | 3 | 3 |
| Magnesium oxide | | | 3 | 3 | 3 | 3 | 3 | 3 | 4 |
| Sodium hydroxide | | | | | | | 3 | 3 | 4 |
| Sodium stearate | 1 | 1 | 1 | 1 | 1 | 1 | 1 | 1 | 1 |
| Degree of swelling (%, 23° C. × 24 hr) | 0.7 | 1.0 | 1.0 | 0.6 | 0.4 | 1.7 | 0.0 | 0.4 | 1.2 |
| Degree of swelling (%, 23° C. × 70 hr) | 1.8 | 2.7 | 1.5 | 2.5 | 1.0 | 2.8 | 0.7 | 0.1 | 1.0 |
| Degree of swelling (%, 23° C. × 166 hr) | 6.2 | 4.1 | 2.4 | 1.6 | 1.2 | 1.6 | 1.3 | 1.8 | 1.6 |

When Ex. 10 and 11 are compared with the above Ex. 1 wherein the same fluorinated polymer was used, in Ex. 10 and 11, the degree of swelling after immersion for 166 hours was smaller than in Ex. 1. The same tendency was observed by comparison between Ex. 12 to 15 and Ex. 2, and by comparison between Ex. 16 to 18 and Ex. 3.

From these results, it has been confirmed that it is possible to prevent swelling due to kerosene by the incorporation of various additives.

With the fluorinated polymer which is scarcely swelled by kerosene as mentioned above, when it is mixed with cement and water to form a cement slurry, which is then used for cementing and hardened, even if oil such as petroleum is penetrated under high-temperature and high-pressure conditions as in an oil well for oil drilling, it is possible to prevent swelling of the polymer by the oil thereby to prevent cracking of the hardened structure. Therefore, the effect to improve the liquid proofing property by the addition of the polymer can be maintained for a long period of time.

Further, with the fluorinated polymer having high durability against hot alkali, it is possible to increase the cement strength as a polymer cement in the above cementing. Further, by preparing a cement slurry using the re-dispersible polymer powder, it is possible to prepare a cement slurry having good dispersibility.

### INDUSTRIAL APPLICABILITY

According to the present invention, it is possible to provide a polymer cement composition which, when hardened, is less susceptible to cracking by oil such as petroleum, and a cementing method using it.

This application is a continuation of PCT Application No. PCT/JP2014/059882, filed on Apr. 3, 2014, which is based upon and claims the benefit of priority from Japanese Patent Application No. 2013-082105 filed on Apr. 10, 2013. The contents of those applications are incorporated herein by reference in their entireties.

What is claimed is:

1. A polymer cement composition comprising cement, a polymer and water, wherein the polymer is a fluorinated polymer, and the degree of swelling obtained by the following measuring method is from 0 to 30%:
(Method for measuring degree of swelling)
A 1 mm-thick sheet made of the polymer is immersed in kerosene at a temperature within a range of 23±2° C. for 24 hours, whereby the volume change (%) as between before and after the immersion is measured, and the measured value is taken as the degree of swelling.

2. The polymer cement composition according to claim 1, wherein the fluorinated polymer is at least one member selected from the group consisting of the following fluoro-rubber (F1) and the following fluoro-resin (F2):
Fluoro-rubber (F1): at least one fluoro-rubber selected from the group consisting of a vinylidene fluoride/hexafluoropropylene type copolymer (FKM), a tetrafluoroethylene/propylene type copolymer (FEPM) and a tetrafluoroethylene/perfluoro(alkyl vinyl ether) type copolymer (FFKM),
Fluoro-resin (F2): at least one fluoro-resin selected from the group consisting of an ethylene/tetrafluoroethylene type copolymer (ETFE), a tetrafluoroethylene/perfluoro(alkyl vinyl ether) type copolymer (PFA), a polytetrafluoroethylene (PTFE), a polyvinylidene fluoride (PVDF), a tetrafluoroethylene/hexafluoropropylene type copolymer (FEP), a polychlorotrifluoroethylene (PCTFE) and an ethylene/chlorotrifluoroethylene type copolymer (ECTFE).

3. The polymer cement composition according to claim 2, wherein the fluorinated polymer contains the fluoro-rubber (F1).

4. The polymer cement composition according to claim 1, wherein the volume change measured by the following measuring method, of the polymer, is from −30 to 30%:
(Method for measuring volume change)
A 1 mm-thick sheet made of the polymer is immersed in a 50% sodium hydroxide aqueous solution at a temperature within a range of 100±5° C. for 72 hours, whereby the volume change as between before and after the immersion is measured.

5. The polymer cement composition according to 1, wherein the polymer is in powder form, and its average particle size is from 0.5 to 1.5 mm.

6. The polymer cement composition according to claim 1, wherein a filler is added to the polymer.

7. The polymer cement composition according to claim 1, wherein the polymer is a re-dispersible polymer powder.

8. The polymer cement composition according to claim 1, wherein the polymer content in the polymer cement composition is such that the ratio (P/C) of the mass (P) of the polymer to the mass (C) of the cement is at least 10% and at most 40%.

9. The polymer cement composition according to claim 1, wherein the fluorinated polymer is a tetrafluoroethylene/propylene binary copolymer, a tetrafluoroethylene/propylene/vinylidene fluoride ternary copolymer, a tetrafluoroethylene/perfluoro(alkyl vinyl ether) type copolymer, or an ethylene/tetrafluoroethylene type copolymer.

10. The polymer cement composition according to claim 1, wherein carbon black is added to the fluorinated polymer in an amount of from 5 to 100 parts by mass per 100 parts by mass of the fluorinated polymer.

11. A cementing method having a step of conducting cementing by using the polymer cement composition as defined in claim 1.
